(19) United States
(12) Patent Application Publication
(10) Pub. No.: US 2016/0179868 A1
(43) Pub. Date: Jun. 23, 2016

(54) METHODOLOGY AND APPARATUS FOR CONSISTENCY CHECK BY COMPARISON OF ONTOLOGY MODELS

(71) Applicant: GM GLOBAL TECHNOLOGY OPERATIONS LLC, Detroit, MI (US)

(72) Inventors: Dnyanesh RAJPATHAK, Banglore (IN); Ramesh SETHU, Troy, MI (US); Prakash M. PERANANDAM, Bangalore (IN)

(21) Appl. No.: 14/574,962

(22) Filed: Dec. 18, 2014

(51) Int. Cl. G06F 17/30; G06F 17/27

(52) U.S. Cl. CPC G06F 17/30371; G06F 17/30705; G06F 17/30734; G06F 17/274; G06F 17/2785; G06F 17/277

(57) ABSTRACT

A method of generating ontology models from requirement documents and software and performing consistency checks among requirement documents and software code utilizing ontology models. Terms in the plurality of requirement documents obtained from a database are identified. A processor assigns a part-of-speech tag to each term. The part-of-speech tag indicates a grammatical use of each term in the requirement documents. The processor classifies each term based on the part-of-speech tags. The classification identifies whether the each term is a part, symptom, action, event, or failure mode to constitute an ontology. The processor constructs an ontology-based consistency engine as a function of the ontologies. A consistency check is performed by applying the ontology-based consistency engine between ontologies extracted from two context documents. Inconsistent terms are identified between the context documents. At least one of the context documents having inconsistent terms is corrected.

### BACKGROUND OF INVENTION

An embodiment relates generally to requirement document and software code consistency checks in terms of using ontology models constructed from requirement documents and software code.

In system development process, requirements documents provide necessary information about the functionalities that software must provide for the successful function of a system. Requirements are typically captured in free-flowing English language and the resulting requirement documents are spread over hundreds of pages. A plurality of functional requirements may have some overlapping functionalities as well as sub functionalities. As a result, inconsistencies in the similar functions may cause errors in software either causing or resulting in faults. Typically, a subject matter expert SME reviews the requirement document to identify the inconsistency and correctness issues and rectify them to improve the consistency the requirement documents as well as the software code. Furthermore, when a fault is observed in field with a specific entity (e.g., vehicle), the root cause of such fault can also be traced back either to its requirement document or to software which is getting executed in the modules installed in a vehicle. Given the length of a requirement document and number of software algorithms associated with the requirements, the task of manually linking appropriate requirements in a mental model is a non-trivial, time consuming and error prone exercise.

### SUMMARY OF INVENTION

An advantage of an embodiment is the identification of inconsistencies between requirements documents, and between requirements and software code which enables fault traceability between different subsystems. The invention also facilitates tracing the faults observed with vehicles to their requirement documents or to the software which is installed in the modules that are part of the vehicle assembly. The embodiments described herein utilize a comparison of extracted ontologies from both requirement documents, software code, and from the data collected when the faults are observed in field for identifying inconsistencies. The embodiments described herein can handle mass amounts of data obtained from various heterogeneous sources as well as determining root-causes at a requirement document level and software code level which improves product quality by minimizing warranty cost.

An embodiment contemplates a method of applying consistency checks among requirement documents and software code. Terms in the plurality of requirement documents obtained from a database are identified. A processor assigns a part-of-speech tag to each term. The part-of-speech tag indicates a grammatical use of each term in the requirement documents. The processor classifies each term based on the part-of-speech tags. The classification identifies whether the each term is a part term, symptom term, action term, event term, or failure mode term. The processor constructs an ontology-based consistency engine as a function of the classified terms. A consistency check is performed by applying the ontology-based consistency engine between ontologies extracted from two context documents. Inconsistent terms are identified between the context documents. At least one of the context documents having inconsistent terms is corrected.

### BRIEF DESCRIPTION OF DRAWINGS

FIG. 1 is a block diagram of a general flow process consistency check requirement technique.

FIG. 2 is a block diagram of the overall methodology of the requirement linking technique.

FIG. 3 is a flow diagram for identifying critical n-grams.

FIG. 4 is an exemplary POS tagging process utilizing the critical N-grams.

FIG. 5 is a flowchart for an exemplary probability estimation for POS tagging.

FIG. 6 is a flowchart for associating probabilities with contextual information.

FIG. 7 illustrates utilization of a training table with testing data.

FIG. 8 illustrates an exemplary ontology based consistency check engine.

FIG. 9 illustrates a flowchart for a method for ontology development.

FIG. 10 illustrates an exemplary domain specific ontology.

FIG. 11 illustrates and exemplary instance of the ontology.

### DETAILED DESCRIPTION

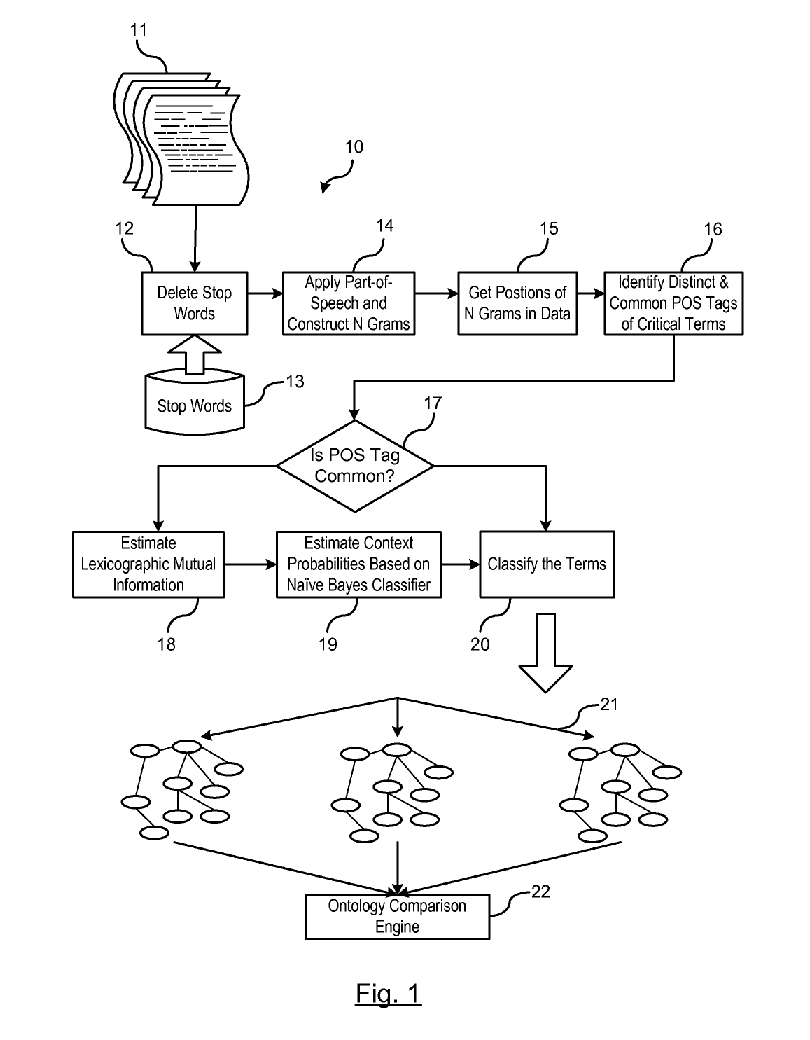

FIG. 1 illustrates a block diagram 10 of a general flow process of an ontology-based consistency engine. While the embodiment described herein is a vehicle-based system, it is understood that the system may be applied to various other system including aircraft or other non-automotive-based systems. The ontology-based consistency engine utilizes one or more processors, memory such as a memory storage device, databases, and output devices for outputting results from consistency checks. Moreover, the processor or another processing unit may perform autonomous correction of the context documents having inconsistent terms. In block 11, requirement documents that include a plurality of requirements are obtained. A respective requirement is selected from the requirement documents. A requirement is a description concerning a part, system, or software that provides details as to the functionality and operation requirements of the part, system, or software.

In block 12, stop words are deleted in the requirement. Stop words add unnecessary noise in the data while performing natural language processing of the data. Stop words consist of, but are not limited to, “a”, “an”, “the”, “who”, “www”, “because”, and “becomes”, which are considered to be non-descriptive. A stop word list may be stored in memory 13, such a memory of a server, a database, a comparison database, or another respective database or memory. Stop words identified in the stop word list obtained from the memory 13 that are part of the extracted information in the requirements are removed. Stop words that are part of critical terms are maintained, and only respective stop words which are not part of critical terms are deleted to maintain the proper meaning of documents.

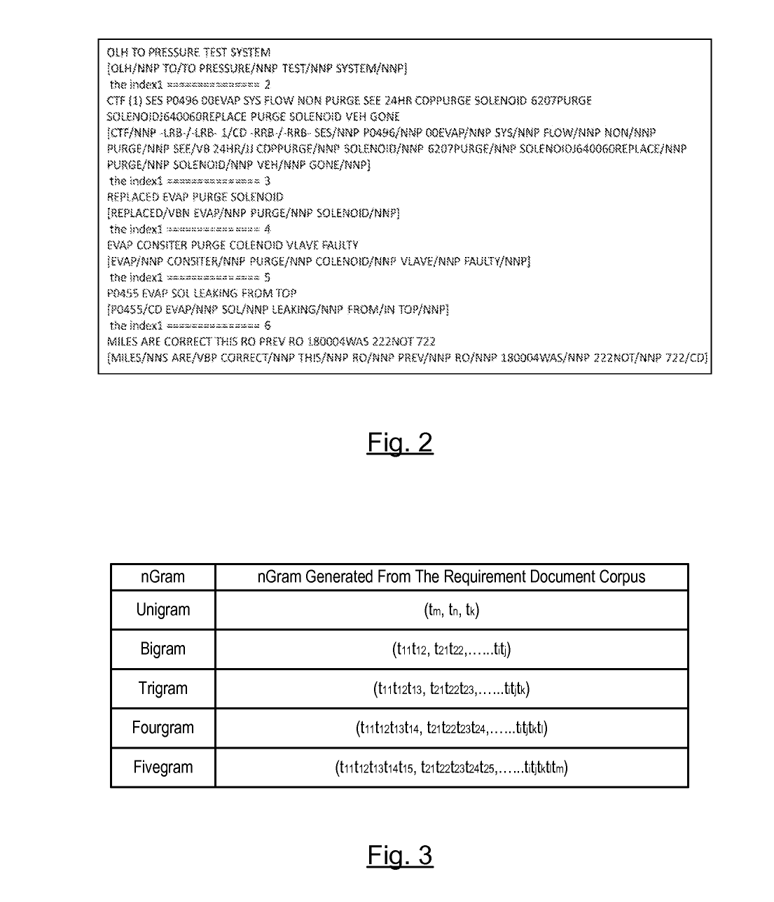

In block 14, parts-of-speech (POS) and n-gram construction is applied to the remaining extracted terms or phrases output from block 12, which is shown in detail in FIG. 2.

In block 15, the positions of the n-grams in the data are determined, which is shown in detail in FIG. 3.

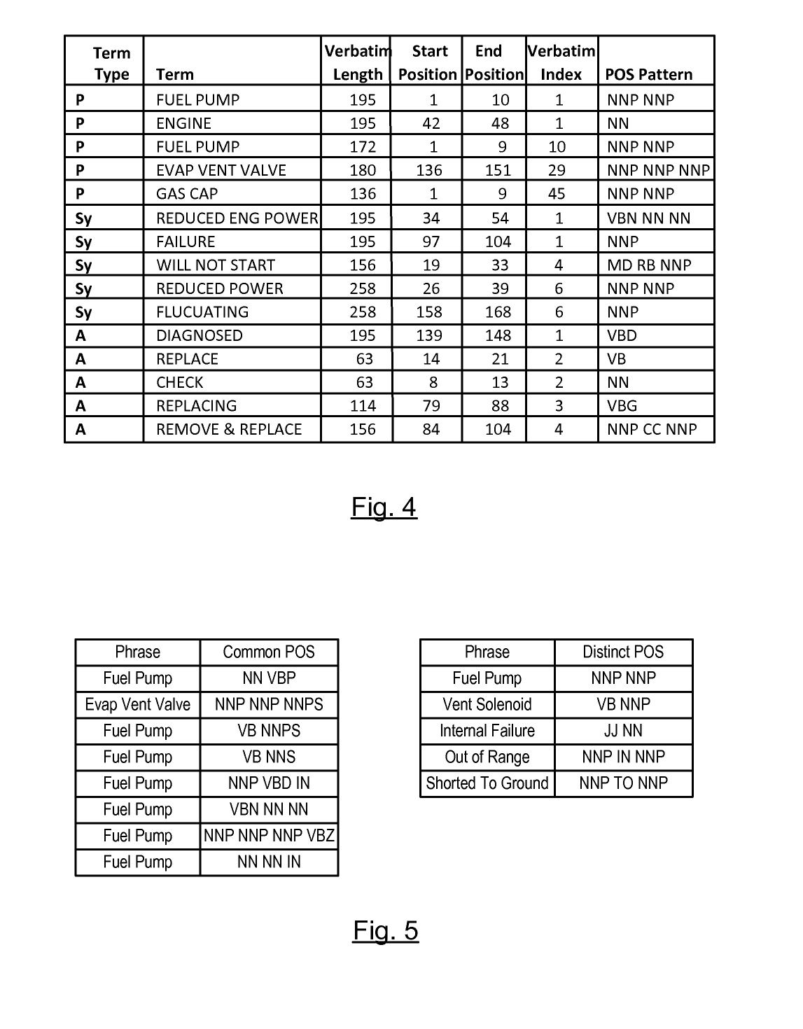

In block 16, distinct and common POS tags of critical terms are identified, which is shown in detail in FIGS. 4 and 5.

In block 17, if a POS tag is common, then the routine proceeds to block 18; else the routine proceeds to block 20.

In block 18, lexicographical mutual information is estimated.

In block 19, context probabilities based on a Naïve Bayes classifier are estimated.

In block 20, the terms are classified as one of a part, symptom, event, failure mode, or action term for constructing the ontology comparison engine.

In block 21, requirement subsystems are generated and identified. An ontology comparison engine is generated and used to perform consistency check between the respective requirement subsystems in block 22. The consistency check may be applied between two or more requirement documents, requirement documents and software code, between software code of different subsystems, and to detect fault traceability between software codes.

FIG. 2 illustrates a parts of speech tagger where verbatim data within the requirements documents are tagged. As shown in FIG. 2, parts of speech are tagged with a respective identifier where phrases, such as “are”, “see”, “24HR”, “purge”, “evap”, “selenoid”, are assigned the following POS tags: “are/VBP”, see/VB″, “24HR/JJ”, “purge/NNP, “evap/NNP”, and “solenoid/NNP”.

A POS tagging module is used to apply tags to the terms. Examples of such tags that include, but are not limited to, can be found in the Penn Treebank Project (http://www.ling.upenn.edu/courses/Fall_2007/ling001/penn_treebank_pos.html). Tags may include, but are not limited to, CC (coordinating conjunction), CD (cardinal number), JJ (adjective), JJR (adjective comparative), NN (noun, singular or mass), NNS (noun plural), NNP (proper noun singular), NNPS (proper noun plural), RB (adverb), RBR (adverb comparative), RBS (adverb superlative), VB (verb, base form), VBD (verb past tense), VBD (verb, present participle), VBN (verb, past participle), VBP (verb, non-3^{rd} person singular present), VBZ (verb, 3^{rd} person singular present). It should be understood that the POS tags herein are exemplary and that different POS identifiers may be used.

N-grams associated with the extracted phrase are identified. The term “gram” refers to the term or terms of the phrase as a whole and “n” refers a number of terms associated with the phrase.

FIG. 3 is an exemplary illustration of an n-gram table. From each requirement document, the following types of n-grams are constructed: uni-grams that include phrases with a single word, (e.g. battery, transmission); bi-grams that include phrases with two words, (e.g. battery dead); tri-grams that include phrases with three words (e.g. body control module, instrument panel cluster, powertrain control module); four-grams that include phrases with four words (e.g. body control module inoperative, transmission control module assembly), and five-grams that includes phrases with five words (e.g. transmission control module assembly failed). The rationale of potentially utilizing possibly an n-gram that is five words long is due to a critical nature of a phrase in some instances containing five words, e.g. Fuel Tank Pressure Sensor Module. For example, critical terms that are the names of parts, symptoms, events, actions, and failure modes may be five words in length.

The n-grams are constructed and utilized when the technique utilized does not use any domain specific ontology (i.e., taxonomy) that would provide an origin or database of terms to identify critical terms from each requirement document. As a result, a natural language processing (NLP) approach may be utilized whereby the n-grams constructed at this stage of the technique are subsequently tagged with their part-of-speech for identifying the correct classification of terms.

FIG. 4 illustrates a table where positions of n-grams in the data are identified. The start and end position of phrases per their POS tags are identified for determining their verbatim length. As shown below, a word window of three words is set on the either side of a respective n-gram. The word window is a variable which shall be decided based on the nature of the document.

XXXXT₁XX[T₂xx^{StartIndex}{Phaseᵢ}^{Endindex}T₃XT₄]XXX

Context information on left=(Phraseᵢ T₂)

Context information on right=((Phraseᵢ T₃), (Phraseᵢ, T₄))

The terms co-occurring with a n-gram in the word window are collected as the context information. This helps identify common phrases and critical phrases.

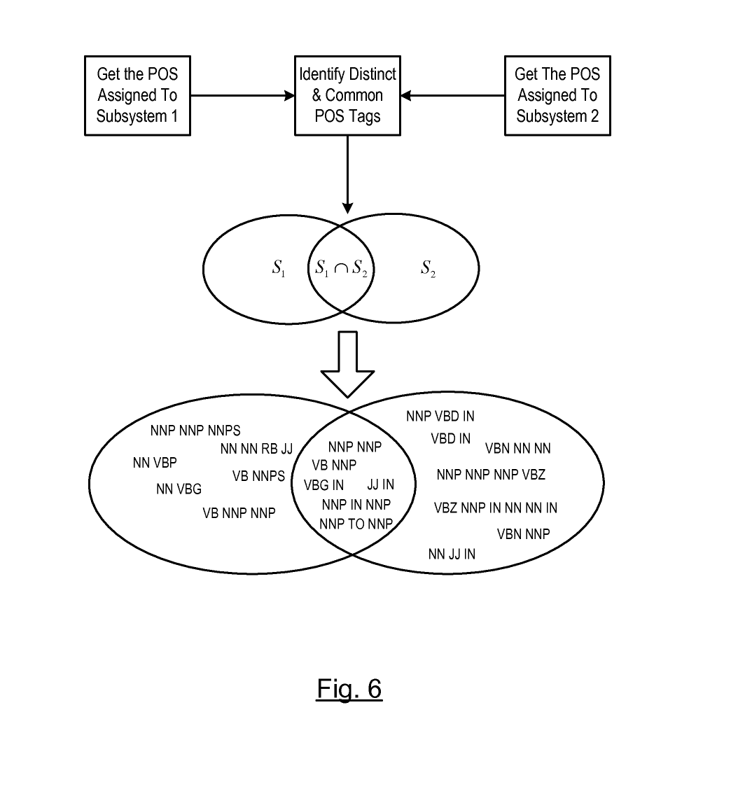

FIG. 5 illustrates tables identifying where common and distinct POS tags associated with phrases. Common POS tags are identified by analyzing the POS assigned to a first subsystem with POS assigned to a second subsystem. The grouping of the POS tags assist in identifying those respective POS tags that are common between subsystems. FIG. 6 illustrates graphical logic intersection, also known as conjunction, between the subsection. As illustrated in FIG. 6, those respective phrases having common POS tags between the two subsystems can be distinguished.

If POS tags associated with the different subsystems are found to be common, then a lexicographic mutual information (LMI) probability technique is applied. The LMI probability technique assists in determining which classification the POS tag should be binned to. For example, the following phrase: “shall not be activated” occurs with both Symptom and Failure Mode phrases: “MD RB VB VBN”. The LMI probability of the following phrases for potential classification is determined:

P(shall not be activated_{sy}|MD RB VB VBN) and

P(shall not be activated_{FM}|MF RB VB VBN) is determined.

The LIM for each respective phrase is determined using the following formulas:

$$LMI ( {Ngram}_{i} , {tag}_{Sy} ) = {log}_{2} \frac{P ( {Ngram}_{i} , {tag}_{Sy} )}{P ( {Ngram}_{i} ) P ( {tag}_{Sy} )}$$

$$LMI ( {Ngram}_{i} , {tag}_{FM} ) = {log}_{2} \frac{P ( {Ngram}_{i} , {tag}_{FM} )}{P ( {Ngram}_{i} ) P ( {tag}_{FM} )}$$

As the respective probabilities are determined, a comparison of the probability of Ngramᵢ, tagᵢ observing together with the probability of Ngramᵢ, tagᵢ observing independently in the data, where tagᵢ ∈ (tag_{sy})Λ(tag_{FM}). As a result, the respective tag (tag_{FM}) or (tag_{sy}) have the higher LMI probability is assigned the classification for the respective phrase.

In addition, a context probability based on Naïve Bayes model may be used which captures the context in which a specific phrase is specified. The Naïve Bayes model predicts the class-membership probabilities. The following steps are used to determine the context probability:

### Step 1:

Let T be the set of tagged n-grams having a specific tag,
(tᵢ^{tag}^{ᵢ}, tⱼ^{tag}^{ⱼ}, tₖ^{tag}^{ₖ})_{Trigram},
(tᵢ^{tag}^{ᵢ}, tⱼᵢ^{tag}^{ⱼ}, tᵢₖ^{tag}^{ₗ})_{Fourgram}, and (tᵢ^{tag}^{ᵢ}, tⱼᵢ^{tag}^{ⱼ}, tᵢₖ^{tag}^{ₖ}, tₘ^{tag}^{ₘ})_{Fivegram}, in the training data.

∃k Classes, (C₁, C₂, . . . , Cₖ) and given a set of T, we estimate whether T belongs to a specific class having maximum posterior probability, i.e.,
(tᵢ^{tag}^{ᵢ}|tⱼ^{tag}^{ⱼ}), P (tₜ^{tag}^{_{k |t}}ᵢ^{tag}^{ᵢ}, tⱼ^{tag}^{ⱼ}), P (tₗ^{tag}^{ₗ}|tᵢ^{tag}^{ᵢ}, tⱼ^{tag}^{ⱼ}, tₖ^{tag}^{ₖ}), etc.

$$\begin{matrix}{t}_{j}^{{tag}_{j}} = {arg}_{{{t}_{j}}^{{tag}_{j}}} max P ( {t}_{j}^{{tag}_{j}} , {t}_{i}^{{tag}_{i}} ) \\ = {arg}_{{{t}_{j}}^{{tag}_{j}}} max P ( \frac{P ( {t}_{i}^{{tag}_{i}} \vert {t}_{j}^{{tag}_{j}} ) P ( {t}_{j}^{{tag}_{j}} )}{P ( {t}_{l}^{{tag}_{l}} )} ) \\ = {arg}_{{{t}_{j}}^{{tag}_{j}}} max P ( {t}_{j}^{{tag}_{j}} , {t}_{i}^{{tag}_{i}} ) P ( {t}_{j}^{{tag}_{j}} )\end{matrix}$$

Step 2:
   Terms co-occurring with the current tagged term provides context, ‘c’ as per the Naïve Bayes a term with a current tag is independent of the tags corresponding to the preceding terms

P(C|tⱼ^{tag}^{ⱼ})=P=({tᵢ^{tag}^{ᵢ}|tᵢ^{tag}^{ᵢ}in C|tⱼ^{tag}^{ⱼ})=Πₜ_{ᵢ}tagᵢ_{_{∈c}}P(tᵢ^{tag}^{ᵢ}|tⱼ^{tag}^{ⱼ})
Step 3:
   Maximum likelihood estimation is calculated as follows:

$$P ( {t}_{i}^{{tag}_{i}} \vert {t}_{j}^{{tag}_{j}} ) = \frac{f ( {t}_{i}^{{tag}_{i}} , {t}_{j}^{{tag}_{j}} )}{f ( {t}_{i}^{{tag}_{i}} )} \& P ( {t}_{j}^{{tag}_{j}} ) = \frac{f ( {t}_{{i}^{′}}^{{tag}_{{i}^{′}}} , {t}_{j}^{{tag}_{j}} )}{f ( {t}_{{i}^{′}}^{{tag}_{{i}^{′}}} )} .$$

After the LMI and context probabilities are determined for the common POS tags, the terms or phrases are classified in their respective bins (e.g., classes). The classified bins may be used for consistency checks between requirement documents, software codes, or between requirement documents and software codes. In addition, the classified bins may be entered into a training table which can be used with test data

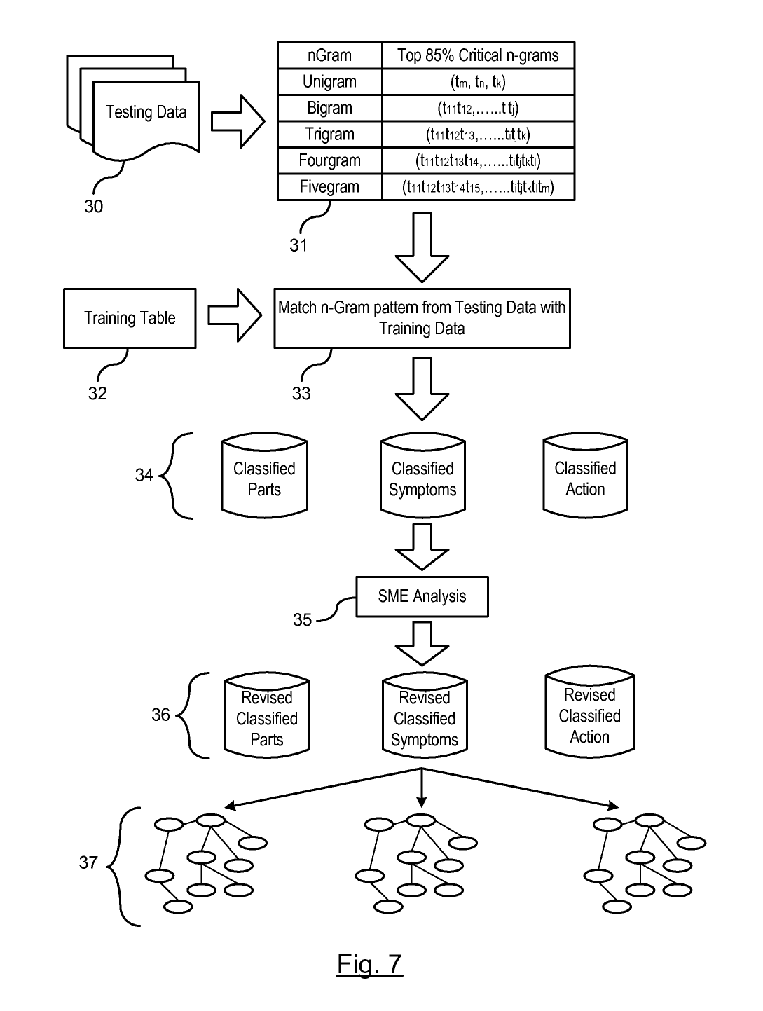

FIG. 7 illustrates the use of the training table in cooperation with the testing data. In block 30, testing data is input to the engine. N-grams are identified in the test data in block 31, and critical n-grams are identified from the test data.

The critical n-grams from block 31 are utilized in cooperation with the training table 32 for matching n-gram patterns in the testing data in block 33. The resulting matches are classified into their respective bins in block 34.

A subject matter expert (SME) analyzes the classified bins in block 35 for determining whether any terms or phrases are misclassified. In block 36, the SME generates revised bins.

In block 37, ontologies are constructed from the respective classified bins. A respective ontology form the software code may be constructed from the results which can be used for consistency checks between software codes and requirement documents. The advantage of the ontology model as shown over other types of modeling, such as finite-state-modeling (FSM) is that FSM is mainly for process flow modeling while ontology can be used for formalizing the domain of discourse. That is, the ontology differentiates between a class-level and instance-level view of the world. As a result, ontology does not require a complete view of the application domain whereas a modeling technique such as finite state modeling requires complete information of the application domain. Also, different class of applications relevant for a specific domain can be modeled without changing domain level classes, but only by capturing new instances that are specific to a new application.

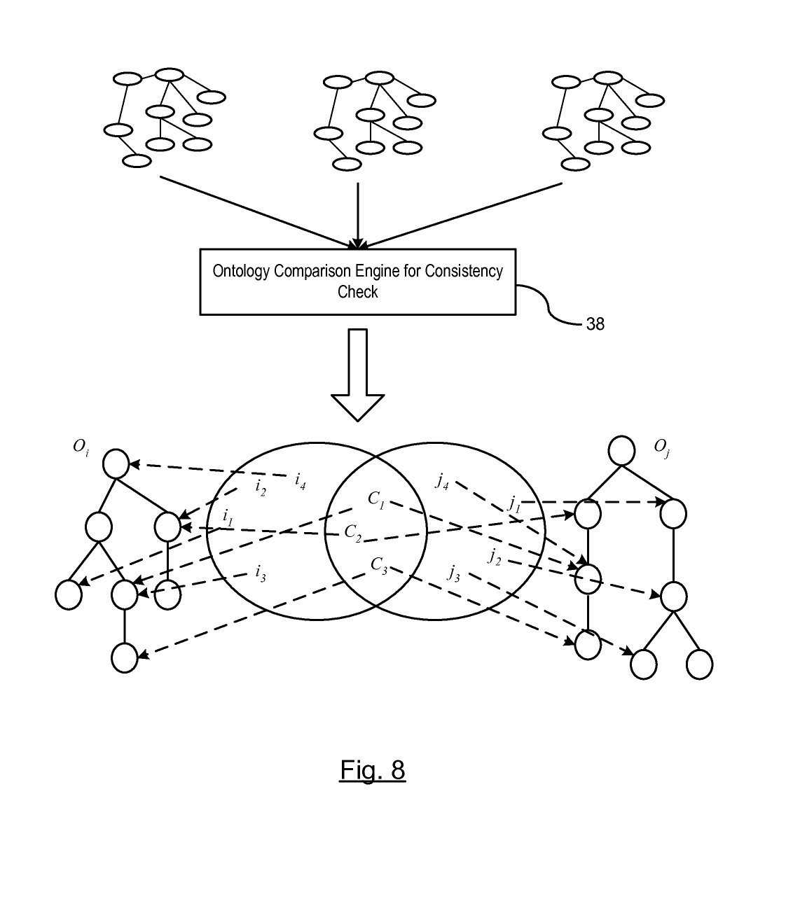

FIG. 8 illustrates an exemplary ontology based consistency check between different subsystems. The ontology engine 38 is applied to a root concept Oᵢ and a root concept Oⱼ. The terms of Oᵢ and Oⱼ are checked for consistency. The following steps are applied:

1. IC(c)=log⁻¹ P(c)

where P(c) is a probability of seeing an instance of concept c (in hierarchical structure P(c) is monotonic.

2. sim(cᵢ, cⱼ)=max_{c∈Sup(c}_{_{i,}}^{c}ⱼ⁾[IC(c)]=max_{c∈Sup(c}_{ᵢ}^{,c}ⱼ⁾[−log p(c)]

where Sup(cᵢ, cᵢ) is a set of concepts that subsumes both cᵢ, cⱼ.
In multiple inheritances with words, more than one sense of similarity of direct super-classes is determined.

3. sim(wᵢ, w₂)=max_{c}_{₁}_{∈Sen(w}_{₂}₎sim(cᵢ, cⱼ)

where Sen(w) denotes the set of possible senses for word w.

The determined similarities may be compared to a predetermined similarities for determining consistency. For example:
If sim(cᵢ, cⱼ)≧0.78, then it is determined that Oᵢ and Oⱼ are consistent with each other.
If sim(w₁, w₂)≧0.64, then it is determined that Oᵢ and Oⱼ are consistent with each other.

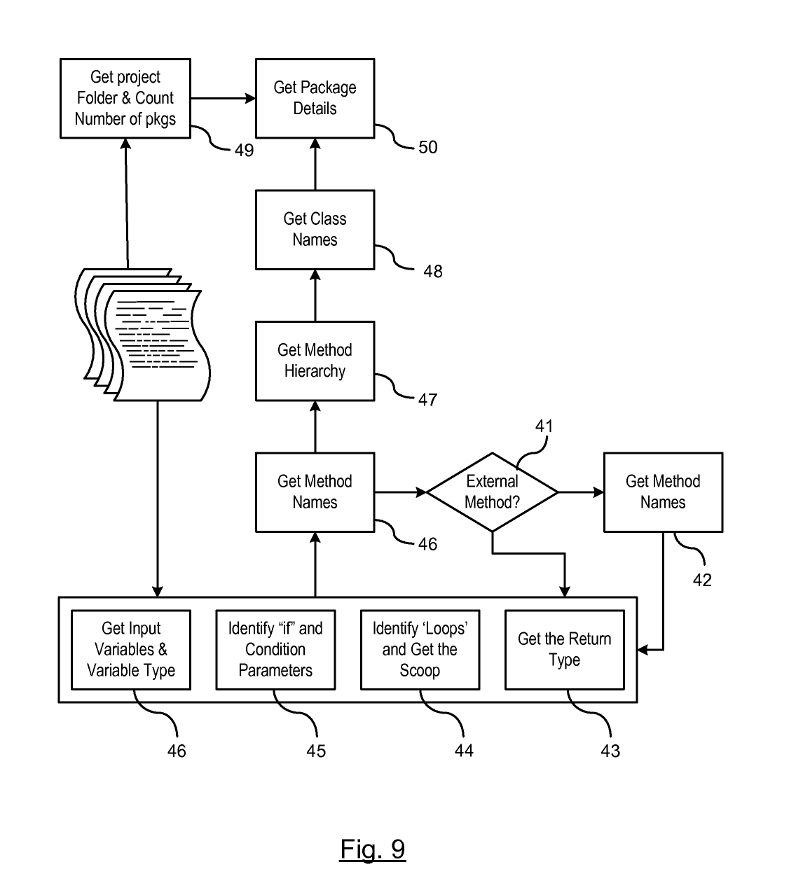

FIG. 9 illustrates a flow chart for a technique of ontology development from software.

In block 40, for each method, the method name is obtained.

A determination is made in block 41 whether an external method is being used. For instance, if one method within its execution is calling another method, then the calling of another method within original method is referred to as an external method. If an external method is not being used, then the routine proceeds to block 43; else, the routine proceeds to block 42.

In step 42, the name of the external method is obtained and the routine proceeds to step 43.

In step 43, the return type is obtained. The notion of the return type herein specifies the output that method is returning after executing the steps. In step 44, loops and their scope are identified. In step 45, “if” parameters and “get” condition parameters are identified. In step 46, input variable and variable types are indentified. Steps 43-46 may be executed simultaneously or sequentially. In addition, the order in which steps 43-46 are performed does not need to be in the order described herein. In response to collecting information and identifying the method, the routine proceeds to step 47.

In step 47, a method hierarchy is obtained.

In step 48, class names are identified.

In step 49, a project folder and a number of count packages are identified. Extraction of the information is applied in this step because the folder typically holds complete information of a specific requirement feature, and therefore, extracting folder information allows relevant information associated with that specific requirement feature to be obtained in a consistent manner.

In step 50, parameters are retrieved from the software code and an ontology is constructed based on the parameter requirements identified in steps 40-50.

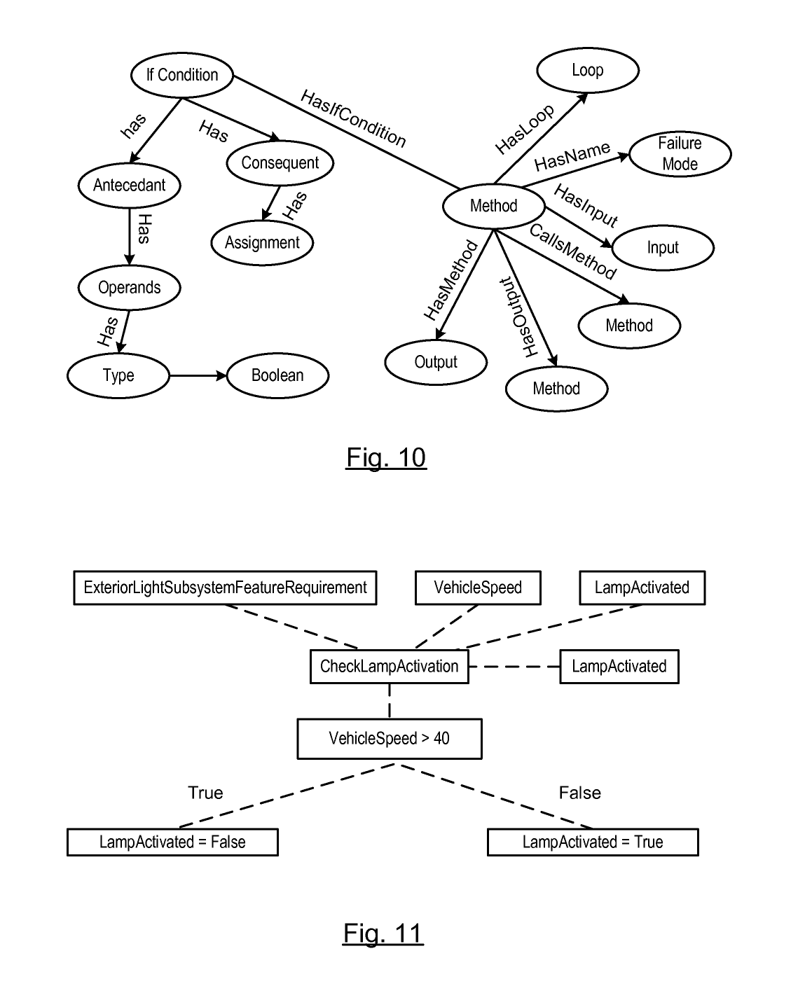

FIG. 10 illustrates an example of a domain specific ontology that can be used to capture critical components of Java code (e.g., software). The ontology shows the classes and the ‘has-a’ relationships between any two classes included in the ontology. In principle, the ontology indicates that a java code may have “Method” and that “Method” may have “Name”, “Loop”, “Input Parameter”, “If Conditions”, etc.

If a comparison is made between a first java code and a second java code, then an instance of the ontology must be created with respect to the first java code and the second java code in order to compare the two java codes.

FIG. 11 shows an instance of the ontology shown in FIG. 10. The instance is created based on the below sample java code:

Java Code:

public class ExteriorLightSubsystemFeatureRequirement {

public boolean checkLampActiviation (int vehicleSpeed,

boolean lampActivated){

if(vehicleSpeed > 40){

lampActivated = false;

}else
lampActivated=true;

return lampActivated;
}

}

The “class” defines a structure, and instances of that class define objects within the class. As shown in FIG. 11, a feature of the java code “ExteriorLightSubsystemFeatureRequirement” has a method called “checkLampActivation” and this method has two respective inputs “vehicleSpeed” and “lampActivated”. This method also has output that is denoted with return statement “lampActivated” and also has an If Condition with a relational operator “>”. This If Condition has consequent assignment statements that are assigned based on “True” or “False” values of the If Condition. It should be understood that FIGS. 10 & 11 are examples of the domain specific ontology and the resulting instance of the ontology, and that invention described herein is not limited to the examples as shown herein.

Faults in the field can be linked to requirement issues. Tracing the fault, such as parameter values captured in the requirements or software, is a technique to identify and correct the issue. Tracing the issues up to the requirements level is required in most instances as an impact of any correction or changes to another part of the system can be easily analyzed at the requirements level compared to advanced levels.

Fault traceability is performed by testing different artifacts independently and manually mapping the results of different artifacts (e.g., mapping requirements and software). The techniques as described herein enables fault tracing in a forward direction such as “requirements level” to “component level” to “system level”, in addition to the backward direction such as “system level” to “component level” to “requirements level”.

While certain embodiments of the present invention have been described in detail, those familiar with the art to which this invention relates will recognize various alternative designs and embodiments for practicing the invention as defined by the following claims.

What is claimed is:

1. A method of performing consistency checks among requirement documents and software code using constructed ontology models comprising the steps of:
identifying terms in the plurality of requirement documents obtained from a database;
assigning, by a processor, a part-of-speech tag to each term, the part-of-speech tag indicating a grammatical use of each term in the requirement documents;
classifying, by the processor, each term based on the part-of-speech tags, the classification identifying whether the each term is a part term, symptom term, action term, event term, or failure mode term;
constructing, by the processor, an ontology-based consistency engine as a function of the classified terms;
performing a consistency check by applying the ontology-based consistency engine between ontologies extracted from two context documents;
identifying inconsistent terms between the context documents;
correcting at least one of the context documents having inconsistent terms.

2. The method of claim 1 further comprising the steps of
identifying whether each term is a part of a phrase in response to assigning a part-of-speech tag to each term; and
grouping the phrases as n-grams having a same number of terms.

3. The method of claim 2 further comprising the steps of:
identifying starting and ending positions of phrases based on the POS tags for determining their verbatim length.

4. The method of claim 3 further comprising the step of determining common phrases as a function of the verbatim length.

5. The method of claim 3 further comprising the step of estimating lexicographic mutual information of the phrase for determining an associated classification in response to determining that two respective phrases includes common parts-of-speech tags.

6. The method of claim 3 wherein the lexicographic mutual information for a first phrase and a second phrase are determined by the following formula:
$$LMI ( {Ngram}_{i} , {tag}_{1} ) = {log}_{2} \frac{P ( {Ngram}_{i} , {tag}_{1} )}{P ( {Ngram}_{i} ) P ( {tag}_{S 1} )}$$
$$LMI ( {Ngram}_{i} , {tag}_{2} ) = {log}_{2} \frac{P ( {Ngram}_{i} , {tag}_{2} )}{P ( {Ngram}_{i} ) P ( {tag}_{2} )} .$$

7. The method of claim 6 wherein the LMI probability associated with the first phrase is compared with the LMI probability associated with the second phrase, and wherein the classification associated with respective LMI having the higher probability is assigned to the first phrase and second phrase.

8. The method of claim 7 wherein a context probability is determined utilizing a Naïve Bayes model by capturing context in which a specific phrase is specified, wherein the LMI probability and the Naïve Bayes model is utilized to assign the classification.

9. The method of claim 1 wherein the consistency check between the two context documents includes a first requirement document and a second requirement document.

10. The method of claim 1 wherein the consistency check between the two context documents includes a first software code and a second software code.

11. The method of claim 1 wherein the consistency check between the two context documents includes a requirement document and a software code.

12. The method of claim 1 wherein the consistency check between the two context documents includes a first requirement document and second requirement document.

13. The method of claim 1 wherein a fault traceability is performed between a first software code and a second software code.

14. The method of claim 1 wherein an instance of the ontology is generated with respect to the first software code and the second software code, wherein respective ontology instances are compared for identifying inconsistencies between the first software code and the second software code.

15. The method of claim 1 wherein a fault traceability is performed between a first software code and a requirements document.

16. The method of claim 1 wherein the consistency check is determined by finding a similarity between a first set of concept terms and a second set of concept terms wherein similarity is determined utilizing the following formulas:
IC(c)=log⁻¹ P(c)
where P(c) is a probability of seeing an instance of concept c, and
sim(cᵢ, cᵢ)=max_{c∈Sup(c}_{ᵢ} _{, c}_{ⱼ}₎[IC(c)]=max_{c∈Sup(c}_{ᵢ}_{, c}_{ⱼ}₎[−log p(c)]
wherein if sim(cᵢ, cᵢ) is greater than a first predetermined threshold, then it is determined that the first and second set of concepts are consistent with each other.

17. The method of claim 15 wherein the consistency check is determined by finding a similarity between a first set of concept terms and a second set of concept terms when a multiple inheritance of words is utilized, wherein the similarity is determined utilizing the following formulas:
IC(c)=log⁻¹ P(c)
where P(c) is a probability of seeing an instance of concept c,
sim(cᵢ, cⱼ)=max_{c∈Sup(c}_{ᵢ}_{, c}_{ⱼ}₎[IC(c)]=max_{c∈Sup(c}_{ᵢ}_{, c}_{ⱼ}₎[log p(c)]; and
sim(wᵢ, w₂)=max_{c}_{₁}_{∈Sen(w}_{₁}_{)c}_{₂}_{∈Sen(w}_{₂}₎ₛᵢₘ₍cᵢ, cⱼ)
where Sen(w) denotes the set of possible senses for word w, wherein if sim(wᵢ, wⱼ) greater than a second predetermined threshold, then it is determined that the first and second set of concepts are consistent with each other.

18. The method of claim 16 wherein the first predetermined threshold is greater than the second predetermined threshold.
